(19) United States
(12) Patent Application Publication
(10) Pub. No.: US 2025/0314113 A1
(43) Pub. Date: Oct. 9, 2025

(54) METHOD FOR OPERATING AN ELECTRIC MOTOR DOOR DRIVE OF A MOTOR VEHICLE

(71) Applicant: Brose Fahrzeugteile SE & Co. Kommanditgesellschaft, Bamberg, Bamberg (DE)

(72) Inventors: Daniel FOERST, Bamberg (DE); Andreas LAPPE, Mistelgau (DE); Moritz SOMMERMANN, Schwabach (DE)

(73) Assignee: Brose Fahrzeugteile SE & Co. Kommanditgesellschaft, Bamberg, Bamberg (DE)

(21) Appl. No.: 19/173,334

(22) Filed: Apr. 8, 2025

(30) Foreign Application Priority Data
Apr. 8, 2024 (DE) 10 2024 203 179.8

(51) Int. Cl. E05F 15/40; E05F 15/611

(52) U.S. Cl. CPC E05F 15/40; E05F 15/611; E05Y 2900/531

(57) ABSTRACT

A method for operating an electric motor door drive of a motor vehicle. A door is driven by an electric motor, with a collision protection sensor. During an adjustment of the door in an adjustment direction, the door is stopped at a predetermined distance from an object that is detected by the collision protection sensor and is present at a position in an adjustment area. The door is moved once again in the adjustment direction when the object is no longer detected and the position is in a middle area of a detection range of the collision protection sensor. An electric motor door drive is also provided.

This nonprovisional application claims priority under 35 U.S.C. § 119 (a) to German Patent Application No. 10 2024 203 179.8, which was filed in Germany on Apr. 8, 2024, and which is herein incorporated by reference.

### BACKGROUND OF THE INVENTION

### Field of the Invention

The invention relates to a method for operating an electric motor door drive of a motor vehicle, comprising an electric motor-driven door and a collision protection sensor. The invention further relates to an electric motor door drive for a motor vehicle.

### Description of the Background Art

Motor vehicles such as passenger cars typically have a number of doors, by means of which an opening in the body of the motor vehicle is covered. The door is generally movably supported on the body of the motor vehicle by means of a bearing, so that the opening in the body can be freed up by adjusting the door. If the door is a side door, it is thus possible to enter the interior of the motor vehicle and/or load the interior with articles. To enhance convenience, the door is usually driven by an electric motor of an electric motor door drive, which likewise includes the door. During operation of the electric motor, the door is moved in an adjustment direction along an adjustment path, which is specified by the bearing that supports the door on the body.

A user of the electric motor door drive may possibly not be able to completely see an adjustment path of the door formed around the adjustment path, and for example may activate the electric motor door drive even though an object is present in the adjustment area. The adjustment area is the region which is traveled by the door along the entire adjustment path when the door is adjusted, and which is defined by the outer contour of the door. The shape of the adjustment area is usually stored, at least implicitly, in a memory of the electric motor door drive during manufacture.

To avoid a collision of the door with the object, which could result in damage to the object and/or the door, the electric motor door drive therefore usually includes a collision protection sensor which monitors the adjustment area. If the object is present in the adjustment area, for example energization of the electric motor is prevented, so that the door is not adjusted. An acoustic signal is generally also output, so that the user is made aware that an adjustment is not possible at that time on account of the object. In one refinement, the door is adjusted until the distance from the object has reached a predefined minimum value. When this is the case, the electric motor is switched off and a collision is avoided. Since the door has been opened by means of the electric motor, the opening in the body is at least partially freed up, so that it is possible to enter or exit the motor vehicle, although with less convenience.

It is possible for the object to move away from the door after the door stops, so that further opening of the door could occur. Such a movement of the door can take place only when it is ensured that the object is no longer present in the adjustment area, since otherwise the door would essentially immediately collide with the object if it had erroneously not been detected. This is made more difficult by the fact that a radar sensor or a camera, which can more reliably detect an object that is moving relative to the collision protection sensor in comparison to a stationary object, is generally used as a collision protection sensor.

In order to prevent a collision, it is possible to initially stop the door at a comparatively large distance from the object and move the door once again when the object is no longer detected. If the object is still present, its detection during the movement now taking place is facilitated/enabled, and if the object is still present then, the door is stopped once again before a collision occurs. A disadvantage here is that if the object does not move for a long period of time, during subsequent movements of the door it comes comparatively close to the object. Alternatively, checking for only a limited number of times is possible. It is also necessary to initially select the distance of the door from the object to be comparatively large. Thus, entry or exit is initially made more difficult for the user, even though the door could be brought closer to the object without danger or damage.

### SUMMARY OF THE INVENTION

The object underlying the invention is to provide a particularly suitable method for operating an electric motor door drive of a motor vehicle, and a particularly suitable electric motor door drive for a motor vehicle, thereby advantageously increasing convenience and/or safety.

The method is used for operation of an electric motor door drive of a motor vehicle. The motor vehicle is in particular land-based and preferably has a multitrack design. It is suitably possible to essentially freely position the motor vehicle, in particular on a roadway. The motor vehicle advantageously has corresponding wheels for this purpose. In summary, it is preferably possible to position the motor vehicle on land, essentially independently of other circumstances. In other words, the motor vehicle is suitably not rail-guided. The motor vehicle is preferably a passenger car or a commercial vehicle, such as a truck or bus.

The electric motor door drive includes a door that is driven, preferably along an adjustment path, by means of an electric motor. In the installed state, the door is suitably movably supported on a body of the motor vehicle by means of a bearing. For example, the bearing is designed in the manner of a hinge, and the door is pivotably supported with respect to the body. Alternatively, for this purpose a longitudinally displaceable support of the door, at least in part, is achieved by means of the bearing, so that the door is a sliding door. The door is preferably a side door.

In particular, the shape of an adjustment area of the door is specified by means of the bearing. The door travels through the adjustment area along the entire adjustment path when the door is adjusted. In other words, the adjustment area corresponds in particular to the spatial region within which the door may be present, at least under certain conditions. An end of the adjustment area is preferably specified by the body, which for example forms a stop for the door. When the door is situated at this end of the adjustment area, the door advantageously rests against the body, and any opening in the body is closed off by the door. The opening is freed up by moving the door along the adjustment path to the other end of the adjustment area.

A further component of the electric motor door drive, for example a length-adjustable component, in particular a spindle, is advantageously mechanically situated between the electric motor and the door. Alternatively or in combination therewith, a cable drum is situated therebetween. A gear, such as a worm gear, is preferably initially driven by the electric motor, by means of which the door is advantageously driven, preferably via the spindle which may be present.

In particular, the electric motor in the installed state is stationarily fastened to the body, which facilitates installation. The electric motor is suited, in particular provided and configured, for this purpose. Alternatively, the electric motor is fastened to the door. The electric motor is, for example, a commutator motor with brushes, or particularly preferably a brushless direct current motor (BLDC). The electric motor door drive suitably includes a control unit or some other control device that provides and/or controls an electrical current for energizing the electric motor, so that the electric motor is operated corresponding to a certain specification. The electric motor advantageously includes a sensor for detecting an adjustment position and speed, such as a rotational speed sensor, on the basis of which a rotational speed of the electric motor can be detected during operation. Due to the mechanical coupling between the electric motor and the door, it is thus possible to determine the speed at which the door is moved. In addition, it is thus also possible to determine the position of the door. By means of the rotational speed sensor, the position of the door is preferably also determined during operation.

The door preferably has a door body. In particular, the door body has, at least in part, a rigid design and is suitably supported on the body by means of the bearing that is possibly present. The electric motor preferably acts on the door body. The shape of the door body in particular is not modifiable, and the door body includes, for example, a door module and/or a portion of an outer skin of the motor vehicle. For example, a window pane of the door is mounted on the door body and preferably adjustably supported there.

The electric motor door drive also includes a collision protection sensor. The collision protection sensor is used to prevent a collision of the door with an object/obstacle when the door is adjusted. The collision protection sensor is suited, in particular provided and configured, for this purpose. For example, the collision protection sensor is used to monitor the adjustment area. For example, the entire adjustment area is monitored by means of the collision protection sensor, so that the detection range of the collision protection sensor encompasses the adjustment area. Alternatively, the detection range of the collision protection sensor is reduced or oriented differently, at least in part, so that only a portion of the adjustment area can be monitored by means of the collision protection sensor. However, the detection range of the collision protection sensor is a comparatively small distance from the door, and in particular has only a maximum distance of 20 cm, 15 cm, or 10 cm. In contrast, the end of the detection range facing away from the door is farther away, and has a distance greater than or equal to 1 m, 5 m, or 10 m, for example.

In particular, by means of the collision protection sensor it is possible to detect an object present in the adjustment area. The object is, for example, an article or a living being such as an animal or a person. In particular, the detection of the object takes place without contact, and the collision protection sensor has a radar sensor, for example. Alternatively, the collision protection sensor has an optical sensor, such as a camera, an ultrasonic sensor, or a capacitive sensor. Alternatively or in combination therewith, the collision protection sensor includes a lidar sensor for this purpose. For example, the collision protection sensor is formed by one of these sensors or has several of these sensors, which for example have the same or different designs. The collision protection sensor particularly preferably also includes an evaluation unit by means of which the measured data provided by the particular sensor are evaluated, so that the object is detected. In particular, fusion of the particular provided sensor data takes place. In summary, the collision protection sensor is used to monitor the adjustment area. Contactless detection of the object in the adjustment area is possible by use of the collision protection sensor, and the collision protection sensor is suited, in particular provided and configured, for this purpose.

The collision protection sensor is an integral part of the door, and in particular is fastened, for example rigidly or movably, to further components of the door. For example, it is possible to move the collision protection sensor relative to further components of the door, in particular separately. The collision protection sensor is preferably fastened to a door module of the door and is suitably covered by means of an outer skin of the door. The collision protection sensor is thus protected from environmental influences.

When the door moves, the collision protection sensor is likewise moved, and its detection range, also referred to as the monitoring range, is thus adjusted. The collision protection sensor can detect the object only when the object is in the detection range. When the collision protection sensor is in operation, the detection takes place in particular when no malfunction is present and the data provided by the collision protection sensor are free of error. In contrast, if the object is outside the detection range, detection of the object is generally not possible.

The method provides that when the door is adjusted in an adjustment direction, the door is stopped at a predetermined distance from an object that is detected by the collision protection sensor and is present at a position in the adjustment area. The adjustment direction is in particular an opening direction. Alternatively, the adjustment direction is a closing direction. In particular, the method is used for both possible adjustment directions of the door. When the door is stopped, it is situated not at the end of the adjustment path, but, rather, between the ends. In other words, the electric motor is in particular switched off early so that the door is in a position between the ends of the adjustment path. If the object is not detected, in particular because it is not present, the door suitably is not stopped, and instead is advantageously adjusted corresponding to the adjustment request, and in particular is brought to the end of the adjustment path or at least to a position that is specified by the adjustment request. Due to the stopping of the door, a collision of the door with the object is thus avoided.

In summary, in the method, in particular a request for adjusting the door is initially detected as received, which is also referred to as an adjustment request. The adjustment request is made, for example, by an input of a user, for example by the user actuating a control element such as a door handle or the like. Alternatively or in combination therewith, an appropriate adjustment request is made by an on-board computer of the motor vehicle, for example.

In particular, the adjustment direction of the door is also specified, at least implicitly, by means of the adjustment request. Following the detection, in particular the electric motor is energized so that the door is moved, i.e., adjusted, in the adjustment direction. An automatic adjustment of the door preferably takes place, so that it is not necessary for the user to apply an additional manual force to the door. Alternatively, the electric motor is used only to assist with a manual adjustment of the door by the user.

The detection of the object takes place, for example, even before the electric motor is energized, or at least also during the adjustment of the door. In particular, the door is stopped when the object is situated in front of the door in the adjustment direction. For example, the door is not left stopped if the object is situated behind the door in the adjustment direction. During the detection the position of the object is also determined, and thus also whether the object is in front of the door or behind the door in the adjustment direction. In addition, it is checked whether the position is in the adjustment area. If the position is outside the adjustment area, the door is adjusted in particular without stopping. The position refers, for example, to the midpoint/center of gravity of the object, or in particular to the portion of the exterior boundary of the object that is closest to the door and situated in the adjustment area.

When the door is stopped, it is spaced apart from the object, in particular the position, by the predetermined distance. This distance is advantageously less than 15 cm, 12 cm, 10 cm, 5 cm, or 2 cm. In particular, the predetermined distance is greater than 1 mm, 2 mm, 5 mm, 1 cm, or 2 cm. Thus, even if an additional force is applied to the door, such as being leaned on by the user or due to action by wind, the door is not unintentionally moved toward the object. For example, the predetermined distance is constant or is selected as a function of the object, for example.

In the method, in addition the door is moved once again in the adjustment direction when the object is no longer detected and the position is in a middle area of the detection range of the collision protection sensor. In other words, even after the door has been stopped, the detection range continues to be monitored by the collision protection sensor, so that detecting the object is possible in principle, namely, when the position is within the detection range. The position, for example, is stationary or changes when the object moves.

If the object is no longer detected, this is due to the fact that either it is no longer present at the position, or that it is not detected by the collision protection sensor because, for example, a malfunction is present, detection using the collision protection sensor is comparatively difficult, or the position is outside the detection range.

When the position is in the middle area of the detection range, detecting the object is possible in principle, and the likelihood that the object is erroneously not detected is comparatively low, even though the collision protection sensor improves the detection of the object when they move relative to one another. When the position is in the middle area, i.e., where the object has been detected, and the object is no longer detected, the object has moved, namely, out of the adjustment area/detection range.

It is thus possible to once again adjust the door without a collision with the object occurring. However, if the object is still present, and the object has erroneously not been detected, an essentially immediate detection of the object takes place when the movement begins, since the position is in the middle area of the detection range. Therefore, the door can be, and is, stopped once again essentially immediately after the movement begins, without a collision occurring. In summary, entry and exit are facilitated for a user if the object has moved. Making a new adjustment request is not necessary, which enhances convenience. In addition, it is ensured that the door is not moved toward the object if the object is still present, i.e., is still detected. In contrast, if the object is no longer detected and the position is not in the middle area of the detection range, but instead is in an edge region of the detection range or outside the detection range, the door is advantageously not moved further, and instead is left in the present position. In these cases, it is not determinable with certainty whether the object has moved away, and discontinuing the further adjustment thus ensures that no collision occurs. Here as well, safety is thus increased.

For example, the middle area includes only the middle half of the detection range. The middle area is thus spaced apart from the edge by at least 25% of the extension of the detection range. However, the middle area is advantageously spaced apart from the edge of the detection range by 10% or more of the extension of the detection range, i.e., in particular of the respective extension of the detection range at that location. The detection range in particular is cone-shaped, with the collision protection sensor situated at the tip of the cone. The middle area is a cone, situated within the detection range, whose cross section perpendicular to the cone axis is offset inwardly, with respect to its edge, by 10% of the extension of the cross section of the detection range. The signals associated with the middle area and provided by the collision protection sensor thus have a comparatively high signal-to-noise ratio, so that the object can be reliably detected at that location. In contrast, the ratio is poorer outside the middle area, and due to artifacts or the like, detection of the object at this location is not always ensured. On account of the 10% factor the middle area is comparatively large, so that renewed adjustment of the door takes place relatively frequently. In one alternative, the size of the middle area is less than or equal to two-thirds, one-half, one-third, one-fourth, 15%, 10%, or 5% of the size of the detection range.

For example, the door is not moved if the object can continue to be detected. Alternatively, the door is moved once again in the adjustment direction even if the object continues to be detected. However, for this purpose the position of the object must have changed, namely, to outside of the adjustment area. In other words, when the object has moved out of the adjustment area, the door also once again moves in the adjustment direction. In this case, a collision of the door with the object is also ruled out. Since the collision protection sensor continues to operate after the door is stopped, the change in the position to outside the adjustment area is also detected without the need for additional work steps. The level of effort is thus not increased.

The door particularly preferably includes the door body that is driven by the electric motor. The door body is stopped at the predetermined distance when the object is detected in the adjustment area. In one refinement, an adjustment part is supported on the door body, and is thus in particular also an integral part of the door. The adjustment part is thus movable/adjustable with respect to the door body, and is an outside mirror or preferably a door handle, for example. The collision protection sensor is attached to the adjustment part. In particular, the collision protection sensor is enclosed by a housing of the adjustment part and is thus protected. The adjustment part is advantageously driven by a further electric motor, so that the adjustment part can be adjusted with respect to the door body by means of the further electric motor. The further electric motor in particular drives a gear, which in turn drives the adjustment part, for example. Alternatively, the further electric motor is designed in the manner of a linear motor, for example.

After the door body stops, the adjustment part is moved relative to the door body. As a result, the collision protection sensor is also moved relative to the door body, and thus also relative to the object. The position of the object is redetermined during the movement. Due to the movement of the collision protection sensor, detection of the object is facilitated, and accuracy in determining the position is thus improved. In addition, it can be determined with increased accuracy whether the object is still at the position and/or in the detection range and/or in the adjustment area. Since the adjustment part is moved and the door body is not, a moving mass is reduced, and in addition the adjustment path of the adjustment part is comparatively short. The likelihood of a collision of the adjustment part with the object is thus low, and if a collision takes place anyway, the acting forces are reduced, so that no damage occurs.

The adjustment of the adjustment part with respect to the door body after the door body stops at the predetermined distance from the object is independent of whether the position is in the middle area of the detection range of the collision protection sensor, and instead is regarded as an independent invention. In other words, the invention relates to the method in which, during an adjustment of the door in the adjustment direction, the door, namely, the door body, is stopped at the predetermined distance from the object that is detected by the collision protection sensor and is present in the adjustment area. The adjustment part, which is supported on the door body and attached to the collision protection sensor, is subsequently moved relative to the door body, and during the movement of the adjustment part/collision protection sensor it is checked whether the object is still present. For this purpose, in particular the position of the object is redetermined, namely, during the movement of the adjustment part.

If the position of the object has not changed, the electric motor advantageously does not continue to operate, and the door is thus not further adjusted. In contrast, if the position has changed and/or the object is no longer detected, the object is no longer present. During the movement of the adjustment part and thus also of the collision protection sensor, if the object is no longer detected, or its redetermined position is outside the adjustment area, the door is moved once again in the adjustment direction. In both cases a collision of the door with the object is not possible, whereas convenience for the user is enhanced due to the renewed movement of the door. In particular, during or before the renewed movement of the door in the adjustment direction, the adjustment part is brought into the original position relative to the door body.

For example, the adjustment part is moved relative to the door body only when the object is no longer detected, when the position of the object is in the middle area of the detection range, and/or when the object is outside the detection range. Alternatively, the movement of the adjustment part always takes place after the door stops, regardless of the position of the object. In particular, the adjustment part is moved for a specified period of time after the door body stops. Thus, for the object, in particular when a living being is involved, sufficient time is available to move away, so that the further movement of the door is enabled. In particular, the time period is selected to be between 1 second and 10 seconds, between 2 seconds and 8 seconds, or essentially 5 seconds. The door is thus further moved comparatively quickly when the object is no longer present, thus enhancing convenience for the user. For example, only a one-time movement of the adjustment part takes place. Alternatively, this occurs multiple times, in particular periodically. The adjustment part is adjusted in particular in each case after the specified time period elapses, with the directions advantageously alternating. The adjustment part is thus moved between two different positions and therefore has a defined state. In addition, a change in the position of the adjustment part with respect to the door body is thus avoided, and the number of possible movements relative to the door body is not limited.

The electric motor door drive in the installed state is an integral part of a motor vehicle, and is suited, in particular provided and configured, for this purpose. The motor vehicle is land-based, for example, and for example is a truck, bus, or preferably a passenger car. The electric motor door drive includes an electric motor and a door that is driven thereby. In particular, the door is driven along an adjustment path that is specified based on a bearing which supports the door. The electric motor door drive also includes a collision protection sensor. The collision protection sensor is suited, in particular provided and configured, to monitor at least sections of the adjustment area or the entire adjustment area of the door, i.e., a spatial region that extends along the entire adjustment path, and through which the door travels, so that in particular the adjustment area is defined by the outer contour of the door. The collision protection sensor is an integral part of the door, and for example is rigidly fastened to a door body of the door or is movably supported relative to same. For this purpose an adjustment part, such as a door handle or the like, is advantageously attached to the door body. The collision protection sensor is advantageously rigidly fastened to the door handle, and in particular is situated inside a shell of the door handle.

The electric motor door drive is operated according to a method in which when the door is adjusted in an adjustment direction, the door is stopped at a predetermined distance from an object that is detected by the collision protection sensor and is present at a position in the adjustment area. The door is moved once again in the adjustment direction when the object is no longer detected and the position is in a middle area of a detection range of the collision protection sensor. The adjustment of the door is carried out in particular based on an adjustment request.

The electric motor door drive in particular has a control unit that is provided and configured to carry out the method. The control unit includes, for example, an application-specific integrated circuit (ASIC), or particularly preferably includes a computer that has a suitably programmable design. In particular, the control unit includes a memory medium on which a computer program product, also referred to as a computer program, is stored, wherein when this computer program product, i.e., the program, is executed, the computer is prompted to carry out the method. The electric motor door drive or at least the motor vehicle advantageously has multiple control elements by means of which the adjustment request may be made. The control elements are advantageously connected to the control unit by signaling, in particular via a bus system. The door is a side door, for example, which in the installed state is in particular pivotably supported on a body of the motor vehicle. The invention further relates to a motor vehicle that has such an electric motor door drive.

The invention further relates to a computer program product. The computer program product includes a number of commands which, when the program (computer program product) is executed by a computer, prompt the computer to carry out a method for operating an electric motor door drive of a motor vehicle, which includes a door that is driven by an electric motor, with a collision protection sensor. The collision protection sensor is used in particular to monitor an adjustment area of the door. In the method, when the door is adjusted in an adjustment direction, the door is stopped at a predetermined distance from an object that is detected by the collision protection sensor and is present at a position in the adjustment area. The door is subsequently moved once again in the adjustment direction when the object is no longer detected and the position is in a middle area of a detection range of the collision protection sensor. The computer is advantageously an integral part of a control unit or electronics system of the electric motor door drive and that is formed by same, for example. The computer preferably includes a microprocessor or is formed by same. The computer program product is, for example, a file or a data medium that contains an executable program which automatically carries out the method when installed on a computer.

The invention further relates to a memory medium on which the computer program product is stored. A CD-ROM, a DVD, or a Blu-ray disc is an example of such a memory medium. Alternatively, the memory medium is a USB stick or some other memory which is rewritable, or writable only once, for example. A flash memory, a RAM, or a ROM is an example of such a memory.

The invention further relates to a control unit. The control unit is provided and configured to carry out a method for operating an electric motor door drive of a motor vehicle, which includes a door that is driven by an electric motor, with a collision protection sensor. The collision protection sensor is used in particular to monitor an adjustment area of the door. In the method, when the door is adjusted in an adjustment direction, the door is stopped at a predetermined distance from an object that is detected by the collision protection sensor and is present at a position in the adjustment area. The door is subsequently moved once again in the adjustment direction when the object is no longer detected and the position is in a middle area of a detection range of the collision protection sensor. The control unit has an application-specific integrated circuit (ASIC) and/or a microprocessor, for example, via which the method is carried out, at least in part. In particular, the control unit includes a computer program product which is stored on a memory, and which, when the program is executed by a computer, such as the microprocessor, prompts the computer to carry out the method. The control unit in the installed state is preferably an integral part of the electric motor door drive, and is suited, in particular provided and configured, for this purpose. For example, the control unit is a door control unit. For example, a possible electric motor window lift that is integrated into the door is also controlled by the control unit. The electric motor window lift preferably includes a further electric motor by means of which the window is driven.

The refinements and advantages explained in conjunction with the method are analogously transferable to the electric motor door drive/the motor vehicle/the computer program product/the memory medium/the control unit and among one another, and vice versa.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a side view of a motor vehicle with an electric motor door drive,

FIG. 2 shows a method for operating the electric motor door drive, and

FIG. 3 shows a top view of the motor vehicle while the method is being carried out.

### DETAILED DESCRIPTION

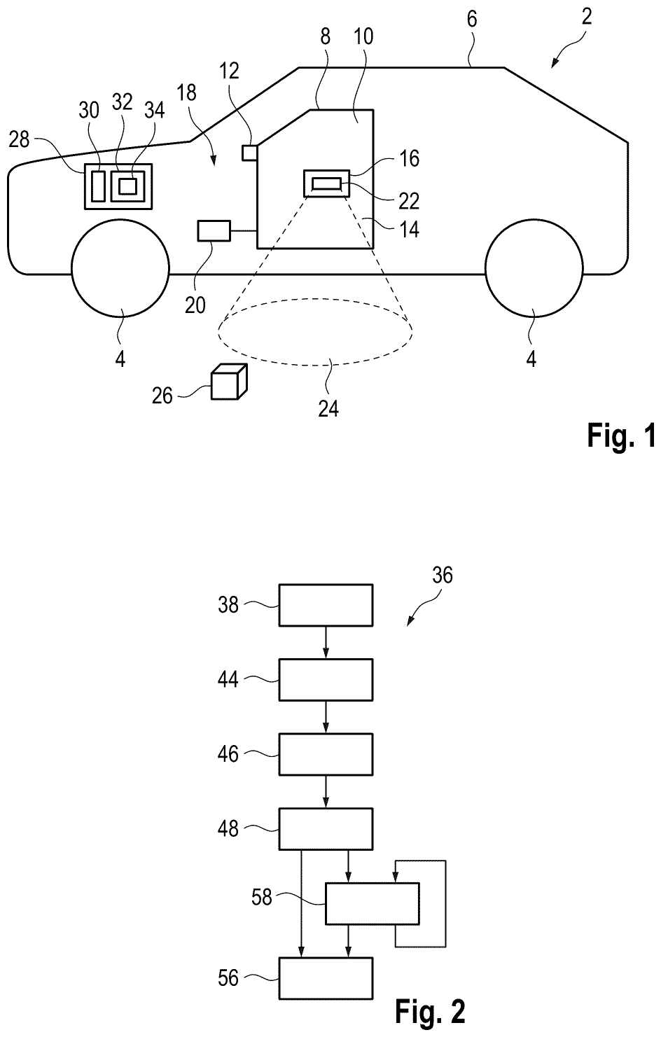

FIG. 1 is a schematically simplified illustration of a motor vehicle 2 in the form of a passenger car. The motor vehicle 2 includes multiple wheels 4 via which contact with a roadway takes place. The wheels 4 are attached via a chassis to a body 6 of the motor vehicle 2, which has an opening 8 through which a user can enter an interior of the motor vehicle 2, which is enclosed by the body 6. The opening 8 is covered or coverable by a door 10 that is pivotably supported on the body 6 by means of a bearing 12. The opening 8 is covered or freed up by swiveling the door 10 with respect to the body 6.

The door 10 is a side door of the motor vehicle 2, and the door 10 has a door body 14 with a rigid design, which is fastened to the bearing 12. A portion of the outer skin of the motor vehicle 2 is formed by the door body 14. In addition, the door body 14 has a door moduleto which an electric motor window lift of the door 10 is fastened. Furthermore, an adjustment part 16, namely, a door handle, is supported on the door body 14. The adjustment part 16 is driven by a further electric motor so that the adjustment part 16 can be adjusted with respect to the door body 14 by operating the further electric motor. In other words, it is possible to extend the door handle so that actuation is enabled for a user. When the door handle is not to be used, for example because the motor vehicle 2 is moving, the door handle is retracted and essentially flush with the door body 14 on the outside. Air resistance against the motor vehicle 2 is thus reduced.

The door 10 is an integral part of an electric motor door drive 18, which includes an electric motor 20 that is affixed on the body side, for example. For example, a gear and a spindle are mechanically situated between the electric motor 20 and the door 10. The door 10 is swiveled with respect to the body 6 at least during operation of the electric motor 20. In summary, the door 10 is driven by means of the electric motor 20.

The electric motor door drive 16 also has a collision protection sensor 22 that is fastened to the door 10, namely, to the adjustment part 16. The collision protection sensor 22 is enclosed and thus protected by a housing of the adjustment part 16. The collision protection sensor 2 has one or more (individual) sensors that are designed as optical sensors, namely, as a camera, ultrasonic sensors, and/or radar sensors. The collision protection sensor 22 also includes an evaluation unit, via which the measured data/signals provided by the (individual) sensors are evaluated. The collision protection sensor 22 has an essentially conical detection range 24. If an object 26 is present in the detection range 24, it is possible for it to be detected by the collision protection sensor 22. In contrast, if the object 26 is outside the detection range 24, detection by the collision protection sensor 22 is not possible. Due to the design of the collision protection sensor 22, detection of the object 26 is improved when the collision protection sensor 22 is moved relative to the object 26. Since the collision protection sensor 22 is fastened to the adjustment part 16, the collision protection sensor and thus also the detection range 24 are moved when the door body 14/the adjustment part 16 moves. In other words, the position/orientation of the detection range 24 is predefined based on the position of the door body 14 and of the adjustment part 16.

The electric motor door drive 18 also has a control unit 28 that is affixed on the body side or fastened to the door body 14, for example. The control unit 28 forms a door control unit which thus controls the electric motor 20 of the electric motor door drive 18, for which energization of the electric motor 20 is set. In addition, operation of the collision protection sensor 22 and of the adjustment part 16 takes place by means of the control unit 28. The control unit 28 has a computer 30 in the form of a programmable microprocessor, and a memory medium in the form of a memory 32. Stored on the memory 32 is a computer program product 34 that includes multiple commands which, when the program is executed by the computer 30, prompt the computer to carry out a method 36, illustrated in FIG. 2, for operating the electric motor door drive 18. In other words, the electric motor door drive 18 is operated according to the method 36, and the control unit 28 is provided and configured to carry out the method 36.

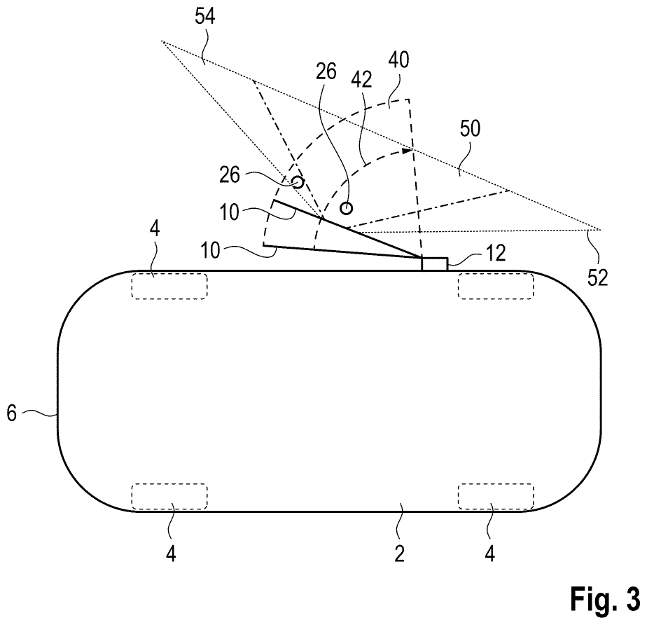

An adjustment request for adjusting the door 10 with respect to the body 6 is received in a first work step 38. The adjustment request is made by a user by actuating the door handle. The electric motor 20 is subsequently operated, so that the door 10, corresponding to the adjustment request, is moved through an adjustment area 40, illustrated in a top view in FIG. 3, in an adjustment direction 42 that is specified by the adjustment request. In the illustrated example, the adjustment direction 42 is the opening direction, and the adjustment area 40 is specified based on the outer contour of the door 10 and of the bearing 12.

The collision protection sensor 22 detects the object 26, provided that it is present and in the detection range 24, in a second work step 44. The position of the object is determined when the object 26 is detected. When the object 26 is in the adjustment area 40, the door 10 is adjusted until it is a predetermined distance from the object 26. A third work step 46 is then carried out in which the electric motor 20 is switched off, so that the door 10 is stopped. As a result, the door 10 has the predetermined distance from the object 26 after completion of the third work step 46. In contrast, if the object 26 is not present or is not in the adjustment area 40, the door 10 is moved through the entire adjustment area 40, or at least to a position that is specified by the adjustment request.

After completion of the third work step 46, i.e., when the door 10 has been stopped, it is checked in a fourth work step 48 whether a condition for further adjustment of the door 10 in the adjustment direction 42 is met. If the position of the object 26 is in a middle area 50 of the detection range 24, such as for the object 26 illustrated in FIG. 3, this is used as such a condition. The middle area 50, the same as the entire detection range 24, is cone-shaped, but is spaced apart from an edge 52 of the detection range 40 by 10% of the extension of the detection range 40. In other words, the middle area 50 is likewise cone-shaped and is enclosed by a hollow cone whose wall thickness is 10% of the particular extension, and which forms an edge region 54 of the detection range 24.

When the position is in the middle area 50, and after the door stops, i.e., in the fourth work step 48, the object 26 is no longer detected, the condition is met and a fifth work step 56 is carried out. In the fifth work step 56, the electric motor 20 is re-energized and the door 10 is moved further in the adjustment direction 42, for example to the end of the adjustment area 40, to some other position specified by the adjustment request, or up to the predefined distance from another object 26 that is likewise in the adjustment area 40. In summary, after stopping, the door 10 is moved once again in the adjustment direction 42 when the object 26 is no longer detected and the position is in the middle area 50 of the detection range 24 of the collision protection sensor 22.

In contrast, if the position of the object 26 is in the edge region 54, as shown in FIG. 3 for the other object 26, the door 10 is not further adjusted, even if the object 26 is no longer detected. Namely, in the edge region 54 the accuracy of the collision protection sensor 22 for determining the presence of the object 26 is reduced, so that it cannot be distinguished with certainty whether the object 26 is not detected due to not being present, or due to malfunction/noise/poor resolution.

The condition for further movement, which thus results in carrying out the fourth work step 48, is likewise met when the object 26 is further detected, but the position of the object 26 has changed. The position must now be outside the adjustment area 40. In this case as well, a collision of the door 10 with the object 26 is ruled out, and there is no damage and/or danger to the object 26/the door 10 when the fifth work step 56 is carried out. In summary, the door 10 is moved once again in the adjustment direction 42 when the change in the position to outside of the adjustment area 40 is detected.

In one refinement, after the third work step 46 is carried out or after the fourth work step 48 is carried out, when the object 26 is no longer detected but the position is not in the middle area 50, a sixth work step 58 is carried out. The sixth work step 58 is not carried out until after a specified time period after the door 10 is stopped has elapsed. In the sixth work step 58, the adjustment part 16 is moved relative to the door body 14, and the door handle is thus extended. In summary, the adjustment part 16 is moved after the specified time period after the door body 14 is stopped, the specified time period being two seconds. As a result, the collision protection sensor 22 is moved relative to the door body 14 and also relative to the object 26, if the object is stationary. Due to the movement, the accuracy in detecting the object 26 is once again improved, even if the object is not in the middle area 50.

If in the sixth work step 58, i.e., during the movement of the collision protection sensor 22, the object 26 is no longer detected or the position of the object 26 is outside the adjustment area 40, the fifth work step 56 is likewise carried out. In summary, the door body 14 that is driven by the electric motor 20 is held at the predetermined distance, but the adjustment part 16 that is supported on the door body 14 is moved relative to the door body 14. During the movement of the adjustment part 16 and thus also of the collision protection sensor 22, the position of the object 26 is redetermined. During the movement, if the object 26 is no longer detected or its position is outside the adjustment area 26, the fifth work step 56 is carried out. In other words, the door 10 is thus moved once again in the adjustment direction 42, and the adjustment part 16 is moved once again into the original position with respect to the door body 14.

During the movement of the adjustment part 16, if the object 26 is still detected at the original position or at some other position within the adjustment area 40, the door body 14 remains in the same position. After the specified time period elapses once again, the adjustment part 16 is moved again, but in the opposite direction. Improved determination of the position of the object 26 is thus once again possible. The adjustment of the adjustment part 16 after the specified time period elapses is repeated until the position of the object 26 has changed to outside the adjustment area 40, or the object 26 is no longer detected. The adjustment of the adjustment part 16 with respect to the door body 14 is also ended when an adjustment request is made to move the door 10 in the direction opposite the adjustment direction 42.

The invention is not limited to the example described above. Rather, other variants of the invention may also be derived by those skilled in the art without departing from the subject matter of the invention. In particular, all individual features described in conjunction with the example may also be combined with one another in some other way without departing from the subject matter of the invention.

What is claimed is:

1. A method for operating an electric motor door drive of a motor vehicle comprising a door that is driven by an electric motor and that has a collision protection sensor, the method comprising:
stopping the door, during an adjustment of the door in an adjustment direction, at a predetermined distance from an object that is detected by the collision protection sensor and is present at a position in an adjustment area; and
moving the door again in the adjustment direction when the object is no longer detected and the position is in a middle area of a detection range of the collision protection sensor.

2. The method according to claim 1, wherein the middle area is spaced apart from an edge of the detection range by at least 10% of the extension of the detection range.

3. The method according to claim 1, wherein the door is also moved again in the adjustment direction when a change in the position to outside of the adjustment area is detected.

4. The method according to claim 1, wherein a door body that is driven by the electric motor is stopped at the predetermined distance, wherein an adjustment part that is supported on the door body and attached to the collision protection sensor is moved relative to the door body, and wherein the position of the object is redetermined during the movement.

5. The method according to claim 4, wherein the door is moved again in the adjustment direction when, during the movement, the object is no longer detected or its position is outside the adjustment area.

6. The method according to claim 4, wherein the adjustment part is moved for a specified period of time after the door body stops.

7. An electric motor door drive for a motor vehicle that comprises a door that is driven by the electric motor and is operated according to the method according to claim 1.
